(19) United States
(12) Patent Application Publication
(10) Pub. No.: US 2006/0289075 A1
(43) Pub. Date: Dec. 28, 2006

(54) Corrugated conduit with reinforcement and flow control features

(76) Inventor: Carl Diez, Quebec (CA)

Correspondence Address: MATHEWS, SHEPHERD, MCKAY, & BRUNEAU, P.A., 29 THANT ROAD, SUITE 201, PRINCETON, NJ, 08540, US

(21) Appl. No.: 11/435,115

(22) Filed: May 16, 2006

Related U.S. Application Data
(60) Provisional application No. 60/681,051, filed on May 16, 2005.

(51) Int. Cl. F16L 9/00

(52) U.S. Cl. 138/173; 138/121; 138/172

(57) ABSTRACT

The present invention relates to a corrugated conduit with reinforcement and flow control features. The corrugated conduit includes an outer surface defining successive and alternating annular peaks and valleys, an inner surface defining successive and alternating annular peaks and valleys, and at least one band positioned along the circumference of the inner surface. When the corrugated conduit has a number of longitudinal, arcuate reinforcing bands, these may be identical or different in width and thickness, and they may be positioned evenly or unevenly apart, depending on the application. As an added measure to control fluid flow, the reinforcing bands may have a contact surface with turbulating texture that causes turbulence when in contact with a fluid.

### CROSS-REFERENCE TO RELATED APPLICATION

This application claims the benefit of U.S. Provisional Application No. 60/681,051 filed on May 16, 2005, which is hereby incorporated by reference in its entirety.

### FIELD OF THE INVENTION

The present invention relates to a conduit used for liquid drainage. More specifically but not exclusively, the present invention relates to a conduit with reinforcement and flow control features.

### BACKGROUND OF THE INVENTION

Corrugated conduits made of plastic material are commonly used for subsurface applications such as domestic, agricultural, forestry and industrial drainage, and waste disposal systems. The corrugations reinforce the conduits, in the transverse direction, to prevent them from collapsing under the load of the soil when they are buried.

Conventional corrugated conduits are often cut into sections as long as 20 or 40 feet. When installed in the field, these 20- or 40-foot long sections can lack rigidity and bend lengthwise. This lack of rigidity can make the installation of the corrugated conduits both tedious and time consuming.

Conventionally, conduits with a smooth inner surface are used, in particular in the forestry industry, to convey and/or deviate fluids, such as streams of water. When a conduit presents a slope in the downstream direction, the flow of water is free from turbulence and therefore can travel very fast. The fast and turbulent-free flow of water can be problematic for aquatic life. For example, fish may be prevented from swimming upstream through the conduits to reach spawning ground. For this reason, regulations have been implemented in certain places to prohibit the installation of conduits with smooth inner surfaces.

### SUMMARY OF THE INVENTION

An object of the present invention is to provide a corrugated conduit with reinforcement and flow control features that serves to eliminate some of the drawbacks of traditional corrugated conduits.

In accordance with an aspect of the present invention, there is provided a conduit for liquid fluid comprising: a corrugated tubular body comprising outer and inner surfaces and opposite open ends, said inner surface defining a passage for the liquid fluid; and at least one reinforcing band positioned along the circumference of- said inner surface; wherein said reinforcing band reinforces said corrugated tubular body when liquid fluid flows in said passage.

In accordance with another aspect of the present invention, there is provided a conduit for liquid fluid comprising a tubular body defining outer and inner surfaces and opposite open ends, said inner surface defining a passage for the liquid fluid; said inner surface comprising at least one band, said band comprising a liquid contact-surface, said liquid contact surface comprising a turbulating texture, wherein when liquid fluid flows within said passage, said turbulating texture is so configured as to impart turbulence to the liquid fluid when coming into contact therewith thereby decreasing the flow velocity thereof.

In accordance with a further aspect of the present invention, there is provided a conduit for liquid fluid comprising: a corrugated tubular body comprising outer and inner surfaces and opposite open ends, said inner surface defining a passage for the liquid fluid; and at least one turbulating and reinforcing band positioned along the circumference of said inner surface; said turbulating and reinforcing band comprising a liquid contact-surface, said liquid contact surface comprising a turbulating texture wherein when the liquid fluid flows within said passage, said turbulating texture is so configured as to impart turbulence to the liquid fluid when coming into contact therewith thereby decreasing the flow velocity thereof reinforcing band reinforces said corrugated tubular body when liquid fluid flows in said passage, said turbulating and reinforcing band reinforcing s said corrugated tubular body during the passage of liquid fluid.

In an embodiment, said turbulating texture comprises a rugged surface. In an embodiment, said turbulating texture comprises a surface having ridges. In an embodiment, said turbulating texture comprises turbulating elements.

In an embodiment, said band comprises a longitudinal member. In an embodiment, said longitudinal member spans the distance between said opposite open ends. In an embodiment, said band comprises an arcuate member. In an embodiment, band is fused with said inner surface. In an embodiment, said inner surface comprises a plurality of said bands. In an embodiment, each of said plurality of bands is spaced at about an equal distance from one another. In an embodiment, said bands of said plurality have substantially similar configurations. In an embodiment, said bands of said plurality have different configurations. In an embodiment, at least one said band of a said plurality has a different configuration that the other said bands of a said plurality. In an embodiment, said inner surface comprises a single band spanning the circumference of said inner surface.

In an embodiment, said inner surface comprises successive and alternating annular peaks and valleys. In an embodiment, said band is fused to said annular peaks of said inner surface.

In an embodiment, said tubular body is made of a material selected from the group consisting a plastic, metal, alloy rubber and any combination thereof. In an embodiment, said tubular body is made of a material selected from polyethylene, polypropylene and a combination thereof. In an embodiment, said tubular body is perforated

In an embodiment, said band is made of a material selected from the group consisting a plastic, metal, alloy rubber and a combination thereof. In an embodiment, said band is made of a material selected from

In an embodiment, said inner surface comprises a plurality of about equally spaced apart bands, each said reinforcing band comprising a longitudinal and arcuate member.

In an embodiment, the present invention relates to a corrugated conduit with reinforcement and flow control features. In one embodiment, the corrugated conduit comprises an outer surface defining successive and alternating annular peaks and valleys, an inner surface defining successive and alternating annular peaks and valleys, and at least one longitudinal, arcuate reinforcing band positioned along the circumference of the inner surface. When the corrugated conduit has a number of longitudinal, arcuate reinforcing bands, these may be identical or different in width and thickness, and they may be positioned evenly or unevenly apart, depending on the application. As an added measure to control fluid flow, the reinforcing bands may have a rugged surface that causes turbulence when in contact with a fluid.

The terminology used herein is for the purpose of describing particular embodiments only and is not intended to limit the scope of the present invention. Unless defined otherwise or the context clearly dictates otherwise, all technical and scientific terms used herein have the same meaning as commonly understood by one of ordinary skill in the art to which this invention belongs.

Use of the singular forms “a,” “an,” and “the” include plural references unless the context clearly dictates otherwise.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “about” is used to indicate that a value includes an inherent variation of error for the device or the method being employed to determine the value.

Terms such as “mounted”, “connected,” “attached,” and “linked” may be used interchangeably herein and encompass direct as well as indirect connection, attachment, linkage or conjugation unless the context clearly dictates otherwise.

Where a value is explicitly recited, it is to be understood that values which are about the same quantity or amount as the recited value are also within the scope of the invention, as are ranges based thereon.

The term “plastic” covers a range of synthetic or semi synthetic polymerization products. They are composed of organic condensation or addition-polymers and may contain other substances to improve performance or economics. There are few natural polymers generally considered to be “plastics”. Plastics are designed with immense variations in properties such as heat tolerance, hardness and resiliency.

The term “metal” designates any of several chemical elements, usually shiny solids that conduct heat or electricity and that can be formed into sheets etc.

The term “alloy” is meant to signify a combination in a compound of two or more elements, at least one of which is a metal, and where the resulting material has metallic properties. The resulting metallic substance generally has properties significantly different from those of its components. For example, steel is stronger than iron, one of its main elements.

The term “rubber” refers to an elastic material obtained from the latex sap of trees (especially trees of the genera Hevea and Ficus) that can be vulcanized and finished into a variety of products, and is meant to include any of various synthetic elastic materials whose properties resemble natural rubber.

The term “band” should be construed herein to include without limitation a “strip”, a “web”, a “piece”, a “member”, and the like.

The foregoing and other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a perspective view of a section of a non-restrictive illustrative embodiment of a conduit according to the present invention;

FIG. 2 is a longitudinal cross sectional view of the conduit of FIG. 1 taken along line 2-2 of FIG. 1;

FIG. 3 is a end elevational view of the conduit of FIG. 1; and

FIG. 4 is a perspective view of a section of a second illustrative embodiment of a conduit according to the present invention.

### DETAILED DESCRIPTION OF THE ILLUSTRATIVE EMBODIMENTS

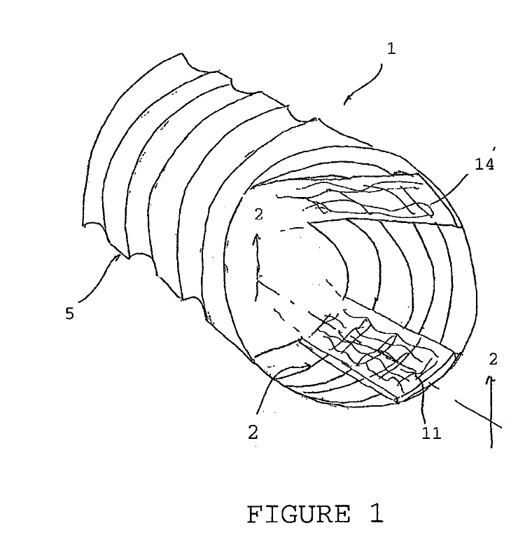

The non-restrictive illustrative embodiments of the conduit with reinforcement and flow control features will now be described with reference to FIGS. 1-4 of the appended drawings.

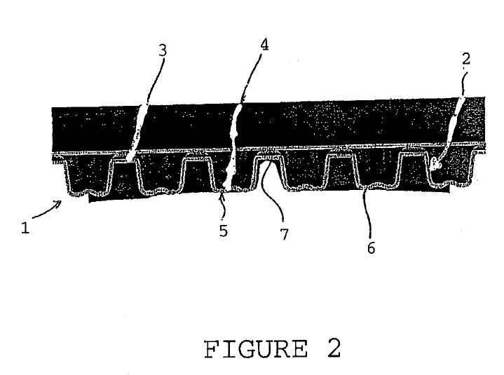

Referring to FIGS. 1 and 2, the conduit is generally identified by the reference numeral 1. In this first embodiment, the conduit 1 is a plastic, cylindrical, non-perforated conduit. However, the present invention could also be applied to conduits made of other materials, such as rubber or stainless steel, as well as to perforate corrugated conduits and to corrugated conduits having a cross section that is other than circular.

The conduit 1 comprises an inner surface 2 defining successive and alternating annular peaks 3 and annular valleys 4.

In the same manner, the conduit 1 comprises an outer surface 5 defining successive and alternating annular peaks 6 and annular valleys 7. Referring to FIG. 2, an inner annular peak 3 corresponds to an outer annular valley 7, and an outer annular peak 6 corresponds to an inner annular valley 4.

As indicated in the foregoing description, corrugated conduits made of plastic material such as 1 are commonly used for subsurface applications such as domestic, agricultural, forestry and industrial drainage, and waste disposal systems. The corrugations reinforce these corrugated plastic conduits transversally to prevent them to collapse under the load of soil when they are buried in the soil.

As also indicated in the foregoing description, corrugated conduits are often cut into sections as long as, for example, 20 or 40 feet. When installed in the field, these 20- or 40-foot long sections of corrugated conduits lack rigidity and bend lengthwise. This lack of rigidity can render the installation of the corrugated conduits both tedious and time consuming.

To reinforce the corrugated conduit 1 lengthwise, longitudinal reinforcing bands of material such as 11, 12, 13, 14 are applied lengthwise on the inner surface 2 of the corrugated plastic conduit 1. The longitudinal reinforcing bands 11-14 are arcuate or semicircular in cross section to fit on the successive, inner annular peaks 3 of the corrugated conduit 1. As illustrated in FIG. 2, the material of each longitudinal reinforcing band 11-14 may be fused or otherwise attached with the material of the inner annular peaks 3 of the corrugated plastic conduit 1. The arcuate cross section of the bands 11-14 and the connection of these plastic bands 11-14 to the inner annular peaks 3 result in a lengthwise reinforcement of the conduit 1.

The bands 11-14 may be made of the same material as the conduit 1 or of a different material as will be understood by one having skill in the art.

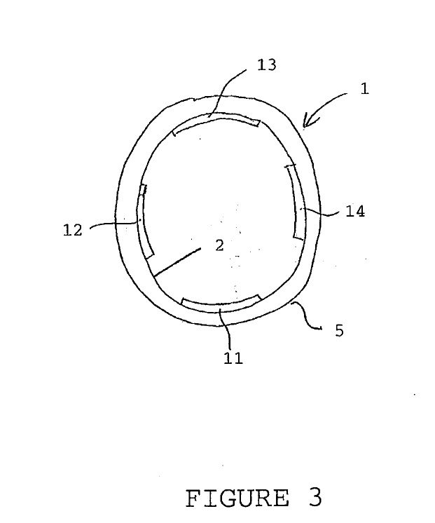

As illustrated in FIG. 3, the conduit 1 comprises four longitudinal reinforcing bands 11-14 spaced apart from each other along the circumference of the inner surface 2 the corrugated conduit 1 by an angle of 90°. However, it is within the scope of the present invention to use, for example, three 120° spaced apart bands, five 72° spaced apart bands, six 60° spaced apart bands, etc. The number, thickness and width of the bands depend on the diameter of the corrugated conduit 1 and the required lengthwise rigidity. For example, in the case of an 18″ inner diameter and 0.125″ thick corrugated conduit, four 90° spaced apart plastic bands 6″ wide and 0.125″ thick have been found suitable for most applications.

In an embodiment, when a conduit is made of plastic or rubber, a minimum of four bands spaced approximately equally apart will provide that the conduit retains a rigidity that is adequate for most purposes. However, in the case of a metallic or stainless steel conduit, a single wide band may be sufficient to confer added support to the conduit. The determination of the number, width, thickness and positioning of the reinforcing bands will therefore vary according to the intended use and material construction of a given corrugated conduit. These parameters are within the purview of one of skill -in the art.

In order to slow down fluid flow velocity, the liquid contact surfaces of the reinforcing bands comprise a turbulating texture. This turbulating texture comprises turbulating elements for imparting a turbulence to passing fluid in contact therewith. This turbulating texture may include a surface that is made rugged and uneven. Any pattern can be made on the surface of the reinforcing bands in order to avoid the creation of smooth surfaces which could have the effect of accelerating fluid flow. As shown in FIG. 1, the surfaces of the plastic bands are comprised of a series of protruding lines and wiggles reminiscent of certain types of mature tree bark (i.e., aspen, oak or maple), but other patterns would be expected to work equally well.

The above described structure will solve the problems caused by the lack of rigidity of the conventional 20- or 40-foot long sections of corrugated plastic conduits, and will facilitate installation of these corrugated plastic conduit sections.

The above described structure will also solve the problem related to the fast and turbulent-free flow of fluids, such as water, produced in plastic conduits with a smooth inner surface and with a slope in the downstream direction, thus allowing fish to reach spawning ground.

When the reinforced corrugated conduit 1 is installed in the position shown in FIG. 3, the top surface of the lower band 11 efficiently conveys small streams of water. Since the top surface of the lower plastic band 11 is rough and uneven, the irregularities create turbulence of the water to slow down the speed of the water flow and allow fish to swim upstream and reach spawning ground.

With larger streams of water, the water flows not only on the top surface of the lower plastic band 11 but also through the inner annular valleys 4 and inner annular peaks 3 of the inner surface 2 of the reinforced corrugated conduit 1 to produce turbulence and slow down the speed of the water flow and allow fish to swim upstream and reach spawning ground. With these larger streams of water, sand and small rocks will accumulated in the inner annular valleys 4 to create a turbulent flow with the above advantages.

Both the corrugated c conduit 1 and the reinforcement bands 11-14 can be made of the same plastic material, for example, polyethylene or polypropylene. Alternatively, the corrugated plastic conduit can be made of a first plastic material and the longitudinal reinforcement plastic bands can be made of a second plastic material compatible with the first plastic material. For example, the corrugated plastic conduit 1 can be made of polyethylene and the reinforcement plastic bands 11-14 can be made of polypropylene, or vice versa. Of course, other types of materials may also be used.

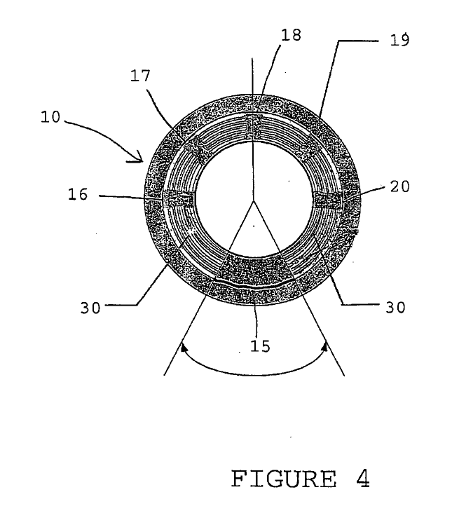

FIG. 4 shows a second embodiment 10 of the reinforced corrugated conduit of the present invention. As shown in this figure, the bands can have different widths within a given conduit. For example, in this embodiment, the lower reinforcing band 15 has a width that is broader than that of reinforcing bands 16-20. The widths of the reinforcing bands can be modified in this way to impart the desired rigidity to a conduit and control fluid flow at the same time. Like the embodiment shown in FIG. 1, the bands 15-20 can be created to have a roughened (or rugged) texture in order to create zones of turbulence 30 that reduce the speed of fluid flow. In addition, the width and spacing of the reinforcing bands will also have an impact on the speed of fluid flow, since the amount of turbulence created will be related to the widths and the distances between the reinforcing bands.

It should be noted that the various features of the various embodiments disclosed herein can be combined in various ways to provide different types of conduits within the scope of the present invention.

Although the present invention has been described hereinabove by way of preferred embodiments thereof, it can be modified without departing from the spirit, scope and the nature of the subject invention, as defined in the appended claims.

What is claimed is:

1. A conduit for liquid fluid comprising:
a corrugated tubular body comprising outer and inner surfaces and opposite open ends, said inner surface defining a passage for the liquid fluid; and
at least one reinforcing band positioned along the circumference of said inner surface;
wherein said reinforcing band reinforces said corrugated tubular body when liquid fluid flows in said passage.

2. A conduit according to claim 1, wherein said reinforcing band comprises a longitudinal member.

3. A conduit according to claim 2, wherein said longitudinal member spans the distance between said opposite open ends.

3. A conduit according to claim 1, wherein said reinforcing band comprises an arcuate member.

4. A conduit according to claim 1, wherein said reinforcing band is fused with said inner surface.

5. A conduit according to claim 1, wherein said inner surface comprises a plurality of said reinforcing bands.

6. A conduit according to claim 5, wherein each of said plurality of reinforcing bands are spaced at about an equal distance from one another.

7. A conduit according to claim 5, wherein said reinforcing bands of said plurality have substantially similar configurations.

8. A conduit according to claim 5, wherein said reinforcing bands of said plurality have different configurations.

9. A conduit according to claim 5, wherein at least one said reinforcing band of a said plurality has a different configuration that the other said reinforcing bands of a said plurality.

10. A conduit according to claim 1, wherein said inner surface comprises a single reinforcing band spanning the circumference of said inner surface.

11. A conduit according to claim 1, wherein said inner surface comprises successive and alternating annular peaks and valleys.

12. A conduit according to claim 11, wherein said reinforcing band is fused to said annular peaks of said inner surface.

13. A conduit according to claim 1, wherein said outer surface comprises successive and alternating annular peaks and valleys.

14. A conduit according to claim 1, wherein said tubular body is perforated.

15. A conduit according to claim 1, wherein said reinforcement band comprises a liquid contact-surface, said liquid contact surface comprising a turbulating texture, wherein when the liquid fluid flows within said passage, said turbulating texture is so configured as to impart turbulence to the liquid fluid when coming into contact therewith.

16. A conduit according to claim 15, wherein said turbulating texture comprises a rugged surface.

17. A conduit according to claim 15, wherein said turbulating texture comprises a surface having ridges.

18. A conduit according to claim 15, wherein said turbulating texture comprises turbulating elements.

19. A conduit according to claim 1, wherein said tubular body is made of a material selected from the group consisting a plastic, metal, alloy rubber and any combination thereof.

20. A conduit according to claim 1, wherein said reinforcing band is made of a material selected from the group consisting a plastic, metal, alloy rubber and a combination thereof.

21. A conduit according to claim 1, wherein said tubular body is made of a material selected from polyethylene, polypropylene and a combination thereof.

22. A conduit according to claim 1, wherein said reinforcing band is made of a material selected from polyethylene, polypropylene and a combination thereof.

23. A conduit according to claim 1, wherein said inner surface comprises a plurality of about equally spaced apart reinforcing bands, each said reinforcing band comprising a longitudinal and arcuate member.

24. A conduit for liquid fluid comprising a tubular body defining outer and inner surfaces and opposite open ends, said inner surface defining a passage for the liquid fluid; said inner surface comprising at least one band, said band comprising a liquid contact-surface, said liquid contact surface comprising a turbulating texture, wherein when liquid fluid flows within said passage, said turbulating texture is so configured as to impart turbulence to the liquid fluid when coming into contact therewith thereby decreasing the flow velocity thereof.

25. A conduit according to claim 24, wherein said turbulating texture comprises a rugged surface.

26. A conduit according to claim 24, wherein said turbulating texture comprises a surface having ridges.

27. A conduit according to claim 24, wherein said turbulating texture comprises turbulating elements.

28. A conduit according to claim 24, wherein said band comprises a longitudinal member.

29. A conduit according to claim 28, wherein said longitudinal member spans the distance between said opposite open ends.

30. A conduit according to claim 24, wherein said band comprises an arcuate member.

31. A conduit according to claim 24, wherein said band is fused with said inner surface.

32. A conduit according to claim 1, wherein said inner surface comprises a plurality of said bands.

33. A conduit according to claim 32, wherein each of said plurality of bands are spaced at about an equal distance from one another.

34. A conduit according to claim 32, wherein said bands of said plurality have substantially similar configurations.

35. A conduit according to claim 32, wherein said bands of said plurality have different configurations.

36. A conduit according to claim 32, wherein at least one said band of a said plurality has a different configuration that the other said bands of a said plurality.

37. A conduit according to claim 24, wherein said inner surface comprises a single band spanning the circumference of said inner surface.

38. A conduit according to claim 24, wherein said inner surface comprises successive and alternating annular peaks and valleys.

39. A conduit according to claim 24, wherein said band is fused to said annular peaks of said inner surface.

40. A conduit according to claim 24, wherein said tubular body comprises a corrugated body, said at least one band acting as a reinforcement band.

41. A conduit according to claim 24, wherein said tubular body is made of a material selected from the group consisting a plastic, metal, alloy rubber and any combination thereof.

42. A conduit according to claim 24, wherein said band is made of a material selected from the group consisting a plastic, metal, alloy rubber and a combination thereof.

43. A conduit according to claim 42, wherein said tubular body is made of a material selected from polyethylene, polypropylene and a combination thereof.

44. A conduit according to claim 24, wherein said band is made of a material selected from polyethylene, polypropylene and a combination thereof.

45. A conduit for liquid fluid comprising:
a corrugated tubular body comprising outer and inner surfaces and opposite open ends, said inner surface defining a passage for the liquid fluid; and
at least one turbulating and reinforcing band positioned along the circumference of said inner surface; said turbulating and reinforcing band comprising a liquid contact-surface, said liquid contact surface comprising a turbulating texture
wherein when the liquid fluid flows within said passage, said turbulating texture is so configured as to impart turbulence to the liquid fluid when coming into contact therewith thereby decreasing the flow velocity thereof reinforcing band reinforces said corrugated tubular body when liquid fluid flows in said passage, said turbulating and reinforcing band reinforcing s said corrugated tubular body during the passage of liquid fluid.
